(19) United States
(12) Patent Application Publication
(10) Pub. No.: US 2010/0027449 A1
(43) Pub. Date: Feb. 4, 2010

(54) Transmitting apparatus, transmitting method, receiving apparatus, receiving method and channel status information updating method of sensor node based on multiple channels

(75) Inventors: Se Han Kim, Daejeon-city (KR); Tae Joon Park, Daejeon-city (KR); Nae-Soo Kim, Daejeon-city (KR); Cheol-Sig Pyo, Daejeon-city (KR); Jae-Yong Lee, Daejeon-city (KR); Byung Chul Kim, Daejeon-city (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/149,379

(22) Filed: Apr. 30, 2008

(30) Foreign Application Priority Data
Dec. 18, 2007 (KR) 10-2007-0133742

(51) Int. Cl. G08C 17/00

(52) U.S. Cl. 370/311

(57) ABSTRACT

Provided are a transmitting apparatus, a transmitting method, a receiving apparatus, a receiving method and a channel status information updating method of a sensor node based on multiple channels. The transmitting apparatus and method transmit a wake-up signal for switching neighbor nodes in a power-saving mode in a transmission range of the sensor node to a wake-up mode in which the neighbor nodes wait to receive a message from the sensor node through the control channel, transmit a preamble message including a list of unused available channels from among the data channels to a receiving node to which data is transmitted from among the neighbor nodes through the control channel, receive an acknowledgement message including information that indicates a channel selected from the available channels from the receiving node through the control channel, transmit a connection confirmation message for switching neighbor nodes other than the receiving node to the power-saving mode through the control channel, and transmit data to the receiving node through the selected channel.

### CROSS-REFERENCE TO RELATED PATENT APPLICATION

This application claims the benefit of Korean Patent Application No. 10-2007-0133742, filed on Dec. 18, 2007, in the Korean Intellectual Property Office, the disclosure of which is incorporated herein in its entirety by reference.

### BACKGROUND OF THE INVENTION

1. Field of the Invention

The present invention relates to a transmitting apparatus, a transmitting method, a receiving apparatus, a receiving method and a channel status information updating method of a sensor node in a multi-channel based sensor network environment and, more particularly, to a transmitting apparatus, a transmitting method, a receiving apparatus, a receiving method and a channel status information updating method of a sensor node for waking up neighbor nodes in a power-saving mode using a wake-up signal, exchanging a control message with a receiving node from among the neighbor nodes to select a single channel, transmitting data through the selected channel and switching neighbor nodes other than the receiving node to the power-saving mode in a multi-channel based sensor network environment to reduce energy consumption, increase the duration of a network and improve the reliability and performance of the network.

The present invention is derived from a research project supported by the Information Technology (IT) Research & Development (R&D) program of the Ministry of Information and Communication (MIC) and the Institute for Information Technology Advancement (IITA) [2005-S-4106-03, RFID/USN sensor tag and sensor node technology development].

2. Description of the Related Art

A wireless sensor network (WSN) composed of dispersed sensors senses information generated in a specific region, collects the information and transmits the information to users through a wireless communication technique for various applications including remote monitoring systems, remote diagnosis systems and unmanned observation systems.

In a sensor network, a sensor can be a thermometer, a hygrometer, a camera, a microphone or a magnetic field measurement sensor. The sensor network has a wireless network function by which sensors included in the sensor network can communicate each other. Devices constructing the sensor network operate by a battery, and thus the devices can use only limited power. This requires high energy efficiency.

Accordingly, the purpose of a wireless sensor network based MAC technology is to reduce energy consumption so as to increase the lifetime of the network and improve the reliability and performance of the network. To achieve this, it is important to develop multi-channel based MAC technology suitable for the purpose of a pursued application in synchronization with a time when multi-channel support of a sensor node is spread. When multiple channels are used, the lifetime of a network increases, the reliability of the network is improved, data throughput increases and quality of service (QoS) is satisfied, and thus importance of the multi-channel based MAC technology as a next wireless sensor network multiple access method is recognized.

There is a difference between a conventional multi-channel wireless network and a multi-channel wireless sensor network because a sensor operates by a small-capacity battery and has small hardware. Hardware for a sensor node has hardware capability lower than that of hardware used in a wireless ad-hoc environment. Furthermore, a sensor node uses a single wireless RF module because the sensor node is small, and thus multiple wireless RF modules cannot be added thereto. Moreover, the sensor node has a battery that is not easy to change and cannot continuously maintain a receiving state, and thus a power-saving design in which sleep and listening modes are repeated is required.

Although the sensor node can use only single RF transceiver, multiple channels are used in a sensor network because of short latency. The sensor network can be used to periodically monitor natural environments and human surrounding environments and to report situations that require emergent follow-up measures, such as forest fires, emergency cases, car accidents and so on. When an emergent situation occurs, a plurality of sensors in the sensor network abruptly transmit emergency data to a sink node. Here, when only a single channel is used, the sensor nodes severely compete so that the emergency data may not be transmitted in the case of competition based MAC protocol. In the case of noncompetition based MAC protocol, a certain degree of latency is guaranteed but the sensor nodes continuously consume a predetermined quantity of energy to achieve the latency.

As described above, a multi-channel based wireless access control technique in a wireless sensor network must consider many things including the lifetime of a battery and latency according to emergency, compared to a multi-channel based wireless access control technique in a conventional wireless network.

### SUMMARY OF THE INVENTION

The present invention provides a transmitting apparatus, a transmitting method, a receiving apparatus, a receiving method and a channel status information updating method of a sensor node for waking up neighbor nodes in a power-saving mode using a wake-up signal in a sensor network environment based on multiple channels including a control channel and a plurality of data channels, transmitting data through a single data channel selected by exchanging a control message with a receiving node from among the neighbor nodes and switching neighbor nodes other than the receiving node to the power-saving mode, to thereby reduce energy consumption, increase the lifetime of a network and improve the reliability and performance of the network.

According to an aspect of the present invention, there is provided a transmitting apparatus of a sensor node based on multiple channels including a control channel and a plurality of data channels, the transmitting apparatus comprising: a wake-up signal transmitter transmitting a wake-up signal for switching neighbor nodes in a power-saving mode in a transmission range of the sensor node to a wake-up mode in which the neighbor nodes wait to receive a message from the sensor node through the control channel; a preamble transmitter transmitting a preamble message including a list of unused available channels from among the data channels to a receiving node to which data is transmitted from among the neighbor nodes through the control channel; an acknowledgement message receiver receiving an acknowledgement message including information that indicates a channel selected from the available channels from the receiving node through the control channel; a connection confirmation message transmitter transmitting a connection confirmation message for switching neighbor nodes other than the receiving node to the power-saving mode through the control channel; and a data transmitter transmitting data to the receiving node through the selected channel.

According to another aspect of the present invention, there is provided a transmitting method of a sensor node based on multiple channels including a control channel and a plurality of data channels, the transmitting method comprising: transmitting a wake-up signal for switching neighbor nodes in a power-saving mode in a transmission range of the sensor node to a wake-up mode in which the neighbor nodes wait to receive a message from the sensor node through the control channel; transmitting a preamble message including a list of unused available channels from among the data channels to a receiving node to which data is transmitted from among the neighbor nodes through the control channel; receiving an acknowledgement message including information that indicates a channel selected from the available channels from the receiving node through the control channel; transmitting a connection confirmation message for switching neighbor nodes other than the receiving node to the power-saving mode through the control channel; and transmitting data to the receiving node through the selected channel.

According to another aspect of the present invention, there is provided a receiving apparatus of a sensor node based on multiple channels including a control channel and a plurality of data channels, the receiving apparatus comprising: a wake-up signal receiver receiving a wake-up signal for switching a power-saving mode to a wake-up mode for waiting to receive a message from a transmitting node in a receiving range of the sensor node from the transmitting node; a preamble receiver receiving a preamble message including a list of available channels from among the data channels from the transmitting node through the control channel in the wake-up mode; a channel selector selecting an unused channel from the available channels; an acknowledgement message transmitter transmitting an acknowledgement message including information that indicates the selected channel to the transmitting node through the control channel; and a data receiver receiving data from the transmitting node through the selected channel.

According to another aspect of the present invention, there is provided a receiving method of a sensor node based on multiple channels including a control channel and a plurality of data channels, the receiving method comprising: receiving a wake-up signal for switching a power-saving mode to a wake-up mode for waiting to receive a message from a transmitting node in a receiving range of the sensor node from the transmitting node; receiving a preamble message including a list of available channels from among the data channels from the transmitting node through the control channel in the wake-up mode; selecting an unused channel from the available channels; transmitting an acknowledgement message including information that indicates the selected channel to the transmitting node through the control channel; and receiving data from the transmitting node through the selected channel.

According to another aspect of the present invention, there is provided a channel status information updating method of a sensor node based on multiple channels including a control channel and a plurality of data channels, the channel status information updating method comprising: receiving a wake-up signal for switching a power-saving mode to a wake-up mode for waiting to receive a message of a transmitting node in a receiving range of the sensor node from the transmitting node; overhearing a control message transmitted and received between the transmitting node and a receiving node through the control channel in the wake-up mode; extracting a selected channel to be used for data communication between the transmitting node and the receiving node from the overheard control message; and updating channel status information corresponding to the extracted selected channel.

According to the present invention, energy consumed to transmit and receive data in a wireless sensor network environment is reduced so as to increase the lifetime of the network and improve the reliability and performance of the network.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a transmitting apparatus of a sensor node according to an embodiment of the present invention;

FIG. 2 is a flow chart illustrating a transmitting method of a sensor node according to an embodiment of the present invention;

FIG. 3A is a block diagram of a hardware device of a sensor node for supporting the transmitting method illustrated in FIG. 2 according to an embodiment of the present invention;

FIG. 3B illustrates power consumption of a primary radio signal for conventional data communication and power consumption of a wake-up radio signal;

FIG. 4A illustrates a structure of a preamble message according to an embodiment of the present invention;

FIG. 4B illustrates a structure of an acknowledgement message according to an embodiment of the present invention;

FIG. 4C illustrates a structure of a connection confirmation message according to an embodiment of the present invention;

FIGS. 5A through 5H illustrate a process of transmitting and receiving a control message and data between a transmitting apparatus of a sensor node and a receiving node according to the present invention;

FIG. 6 is a block diagram of a receiving apparatus of a sensor node according to an embodiment of the present invention;

FIG. 7 is a flow chart illustrating a receiving method of a sensor node according to an embodiment of the present invention;

FIG. 8 is a flow chart illustrating a channel status information updating method of a sensor node according to an embodiment of the present invention; and

FIGS. 9A and 9B are flow charts illustrating a transmitting and receiving method of a sensor node according to an embodiment of the present invention.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those of ordinary skill in the art. Throughout the drawings, like reference numerals refer to like elements.

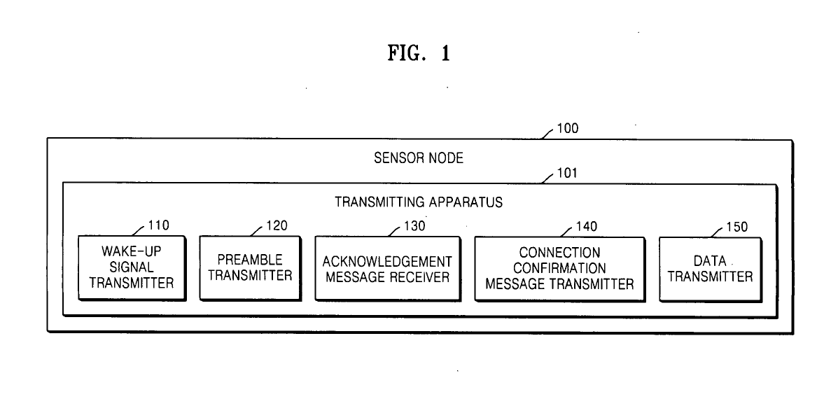

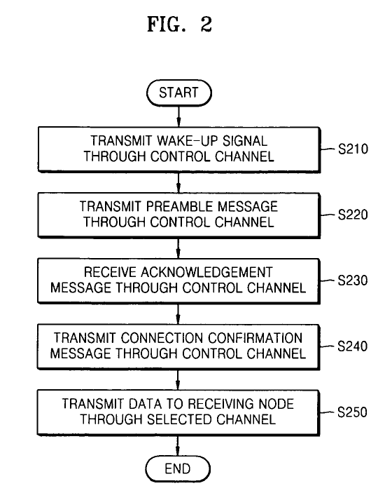

FIG. 1 is a block diagram of a transmitting apparatus 101 of a sensor node 100 according to an embodiment of the present invention, and FIG. 2 is a flow chart illustrating a transmitting method performed in the transmitting apparatus 101 of the sensor node 100 illustrated in FIG. 1. Referring to FIGS. 1 and 2, the transmitting apparatus 101 of the sensor node 100 includes a wake-up signal transmitter 110, a preamble transmitter 120, an acknowledgement message receiver 130, a connection confirmation message transmitter 140 and a data transmitter 150.

In a multi-channel based wireless sensor network environment including a control channel and a plurality of data channels, the wake-up signal transmitter 110 transmits a wake-up signal for switching neighbor nodes which is in a transmission range of the sensor node 100 and in a power-saving mode to a wake-up mode in which the neighbor nodes wait to receive a message from the sensor node 100 in operation S210. The message includes various control messages transmitted from the sensor node 100, such as a preamble message, an acknowledgement message, a connection confirmation message and general data.

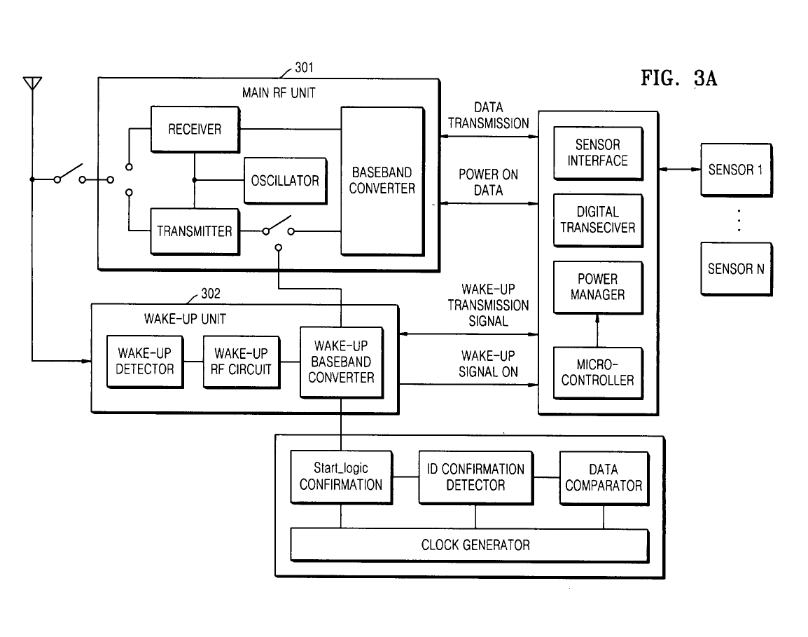

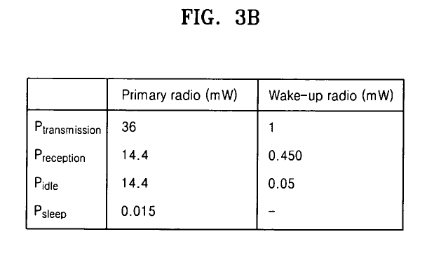

FIG. 3A is a block diagram of a hardware device of the sensor node 100 illustrated in FIG. 1 for supporting the transmitting method according to an embodiment of the present invention. Referring to FIG. 3A, the hardware device of the sensor node 100 includes a main RF unit 301 and a wake-up unit 302.

The sensor node 100 initially operates in a sleep mode. The sleep mode monitors the control channel only using the wake-up unit 302 to detect the wake-up signal when data is not transmitted and received. The sleep mode is referred to as a power-saving mode in the current embodiment of the present invention.

When the sensor node 100 in the power-saving mode detects the wake-up signal, the sensor node 100 is switched from the power-saving mode to the wake-up mode and transmits/receives a control message or data through the control channel or the data channels using the main RF unit 301.

FIG. 3B illustrates power consumption of a primary radio signal for conventional data communication and power consumption of the wake-up radio signal with reference to XBOW MICA2 Mote hardware Specifications of Berkeley MICA2 (“http://www.wbow.com/”) and Pico-radio project “A 400μ W-Rx, 1.6 mW-Tx Super Regenerative Transceiver for Wireless Sensor Networks,” B. Otis, Y. H. Chee, J. Rabaey, IEEE Intl. Solid-State Circuits Conference, ISSCC 2005.

Referring to FIG. 3B, the wake-up radio signal consumes 1 mW for transmission, 0.45 mW for receiving and 0.05 mW in an idle state and the primary radio signal requires 36 mW for transmission, 14.4 mW for receiving and 14.4 mW in the idle state, and thus the power consumption of the wake-up radio signal is considerably lower than that of the primary RF signal. That is, the transmitting method according to the present invention can reduce the power consumption of the sensor node by using the wake-up signal that consumes a very low power while the sensor node operates in the power-saving mode, compared to a conventional multi-channel based transmitting and receiving method using a single transceiver.

The preamble transmitter 120 transmits a preamble message including a list of available channels that are not currently used from among the data channels to a receiving node for transmitting data from among the neighbor nodes to which the wake-up signal transmitter 110 transmits the wake-up signal through the control channel in operation S220.

The transmitting apparatus 101 of the sensor node 100 according to the current embodiment of the present invention can further include a channel status information storage unit (not shown) storing status information of the data channels in order to extract the list of the available channels that are not currently used based on the status information of the data channels, stored in the channel status information storage unit (not shown).

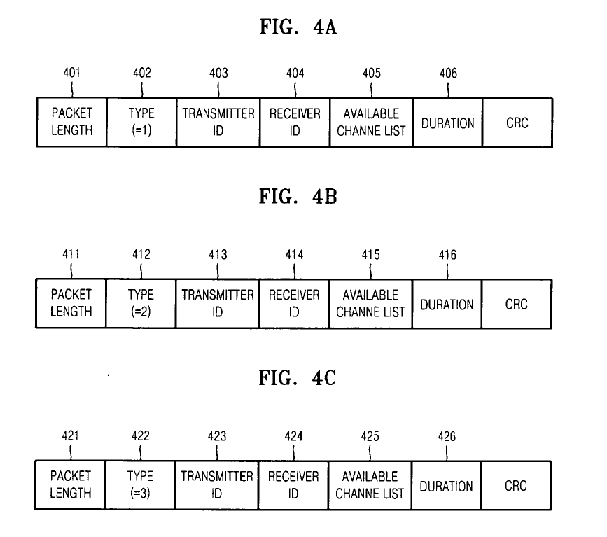

FIG. 4A illustrates a structure of the preamble message transmitted from the sensor node 100 to the receiving node after the wake-up signal is transmitted according to an embodiment of the present invention. The preamble message includes a packet length 401, a type 402, a transmitter ID 403, a receiver ID 404, an available channel list 405 and duration 406.

The packet length 401 includes the total length of the preamble message and the type 402 includes information on the type of the preamble message (for example, Type=1). The transmitter ID 403 and the receiver ID 404 respectively include a node transmitting the preamble message and a node receiving the preamble message. In the current embodiment of the present invention, the transmitter ID includes an identifier of the sensor node 100 and the receiver ID includes an identifier of the receiving node.

The available channel list 405 includes a list of available channels determined by the sensor node 100, which transmits the preamble message, to be unused channels based on the status information of the data channels, stored in the channel status information storage unit (not shown) of the sensor node 100. The duration 406 corresponds to a time estimated to use a channel through which the sensor node 100 transmits/receives data to/from the receiving node, that is, a time required for a session, which is made between the sensor node 100 and the receiving node through the preamble message, to use a data channel after the session is made.

The acknowledgement message receiver 130 receives an acknowledgement message including information that indicates a channel selected from available channels from the receiving node through the control channel in operation S230. Here, the available channels correspond to the available channels included in the preamble message in the form of a list, transmitted from the preamble transmitter 120.

FIG. 4B illustrates a structure of the acknowledgement message according to an embodiment of the present invention. The acknowledgement message includes a packet length 411, a type 412, a transmitter ID 413, a receiver ID 414, a selected channel number 415 and duration 416.

The packet length 411 includes the total length of the acknowledgement message and the type 412 includes information indicating the type of the acknowledgement message (for example, Type=2). The transmitter ID 413 includes information indicating a node that transmits the acknowledgement message and the receiver ID 414 includes information indicating a node that receives the acknowledgement message. In the current embodiment of the present invention, the transmitter ID includes the identifier of the receiving node and the receiver ID includes the identifier of the sensor node 100.

The selected channel number 415 includes the number of a channel selected by the receiving node receiving the preamble message from available channels of the available channel list included in the preamble message and determined to be currently unused based on the status information of the data channels, stored in a channel status information storage unit (not shown) of the receiving node. The duration 416 includes a time estimated to use the selected channel through which the sensor node 100 transmits/receives data to/from the receiving node when the receiving node normally receives the preamble message and succeeds in allocating the selected channel. When the receiving node fails in allocating the selected channel, the duration 416 includes a specific value indicating this failure (for example, Duration=0).

The connection confirmation message transmitter 140 transmits a connection confirmation message that represents connection of the sensor node 100 to the receiving node through the control channel in operation S240.

FIG. 4C illustrates a structure of the connection confirmation message indicating that the sensor node 100 and the receiving node are connected through the selected channel after a transmitting node receives the acknowledgement message according to an embodiment of the present invention. The connection confirmation message includes a packet length 421, a type 422, a transmitter ID 423, a receiver ID 424, a selected channel number 425 and duration 426.

The packet length 421 includes the total length of the connection confirmation message and the type 422 includes information indicating the type of the connection confirmation message (for example, Type=3). The transmitter ID 423 includes information indicating a node that transmits the connection confirmation message and the receiver ID 424 includes information indicating a node that receives the connection confirmation message. In the current embodiment of the present invention, the transmitter ID includes the identifier of the sensor node 100 and the receiver ID includes the identifier of the receiving node.

The selected channel number 425 includes the number of a data channel set to be a channel through which the sensor node 100 and the receiving node transmit and receive data. In the current embodiment of the present invention, the same number as the selected channel number included in the acknowledgement message is stored as the selected channel number 425.

The duration 426 includes a time estimated to use the selected channel through which the sensor node 100 transmits/receives data to/from the receiving node when the acknowledgement message is normally received and the sensor node 100 and the receiving node are successively connected to each other through the selected channel. When the sensor node 100 fails in receiving the acknowledgement message or being connected with the receiving node through the selected channel, the duration 426 includes a specific value indicating this failure (for example, Duration=0).

The connection confirmation message is received by the receiving node and overheard by neighbor nodes other than the receiving node which belong to the transmission range of the sensor node 100. In this case, the neighbor nodes other than the receiving node are switched from the wake-up mode to the power-saving mode.

Furthermore, the neighbor nodes other than the receiving node can obtain information on which data channel is used by the sensor node 100 to transmit data to the receiving node by overhearing the connection confirmation message, and thus channel status information storage units (not shown) of the neighbor nodes other than the receiving node can be updated on the basis of information included in the overheard connection confirmation message.

Referring back to FIGS. 1 and 2, the data transmitter 150 transmits data to the receiving node through the selected channel in operation S250.

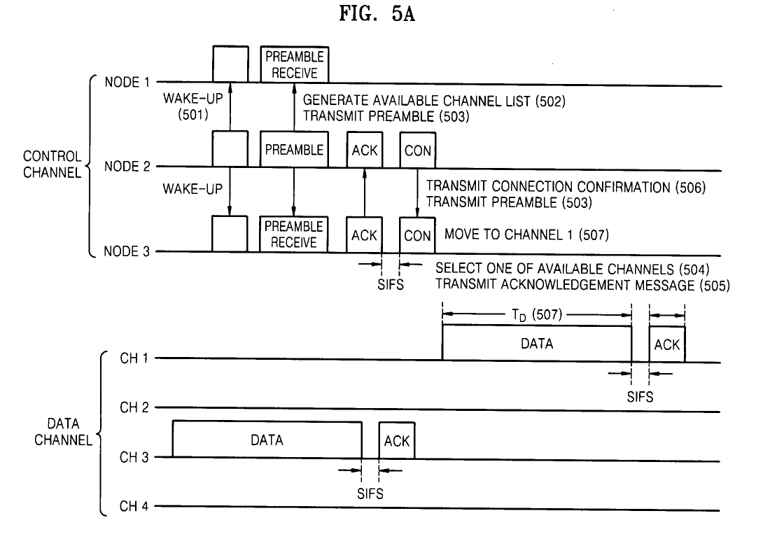

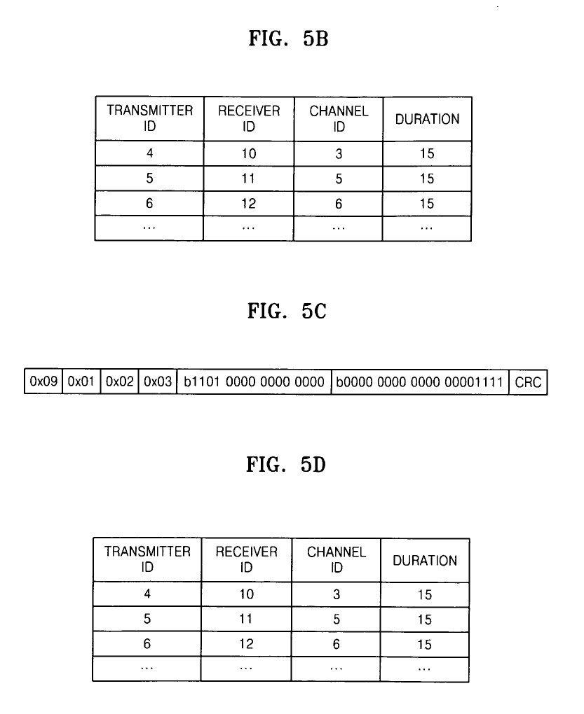

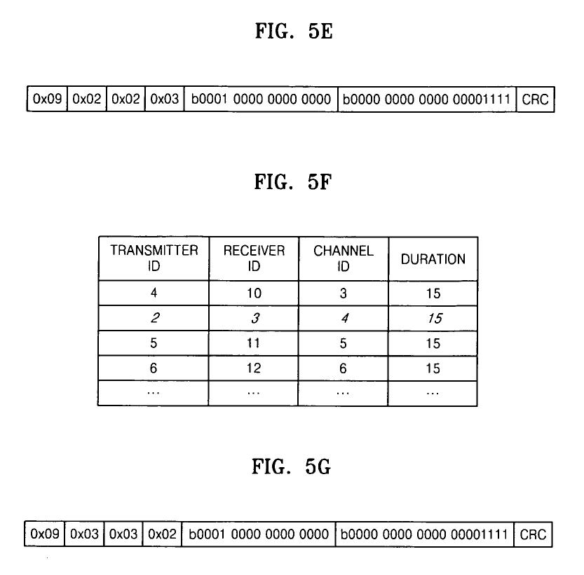

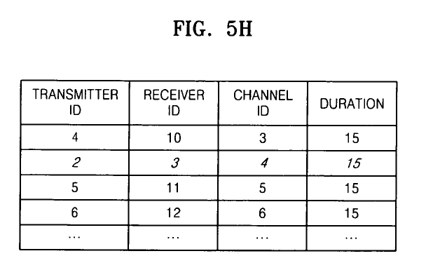

FIGS. 5A through 5H illustrate a process of transmitting and receiving a control message and data between the transmitting apparatus of the sensor node illustrated in FIG. 1 and a receiving node according to the present invention. Referring to FIG. 5A, a wireless sensor network to which the sensor node 100 illustrated in FIG. 1 belongs operates based on multiple channels. The channels include a single control channel and a plurality of data channels. The channels have the same bandwidth and do not overlap.

A node 2 transmits a wake-up signal to a node 1 and a node 3 which belong to a transmission range of the node 2 through the control channel in operation 501. The node 1 and the node 3 are switched from a power-saving mode to a wake-up mode when receiving the wake-up signal to receive a message from the node 2 through a main RF receiver.

The node 2 generates an available channel list on the basis of status information of the data channels, stored as a table illustrated in FIG. 5B in operation 502. Referring to FIG. 5B, channels 1, 2 and 4 belong to the available channel list. The node 2 transmits a preamble message illustrated in FIG. 5C in operation 503. The available channel list to which the channels 1, 2 and 4 belong can be represented in the form of a channel list map such as [1101].

The node 1 and the node 3 receive the preamble message from the node 2, confirm a transmitter ID and a receiver ID and respectively compare the transmitter ID and the receiver ID with their own IDs. The node 1 ignores the preamble message because the receiver ID does not correspond to the ID of the node 1. The node 3 selects a channel that is not currently used from the channels 1, 2 and 4 belonging to the available channel list of the preamble message on the basis of the status information of the data channels stored as a table illustrated in FIG. 5D because the receiver ID corresponds to the ID of the node 3 in operation 504.

Referring to FIG. 5D, the node 3 selects the channel 1 and transmits an acknowledgement message illustrated in FIG. 5E because all the channels 1, 2 and 4 are not used in operation 505. The node 2 receives the acknowledgement message from the node 3, corrects status information of the selected channel as illustrated in a table of FIG. 5F and transmits a connection confirmation message illustrated in FIG. 5G in response to the acknowledgement message in operation 506.

The node 2 and the node 3 transmit and receive data through the channel 1 for a duration TD in operation 507. The node 3 receives the connection confirmation message from the node 2 and corrects the status information of the selected channel as illustrated in a table of FIG. 5H.

The node 1 can overhear the acknowledgement message or the connection confirmation message, extract information on the selected channel from the connection confirmation message and correct the status information of the selected channel. The node 1 is switched from the wake-up mode to the power-saving mode when overhearing the connection confirmation message. The nodes 1, 2 and 3, that is, all the nodes participating in communication, delete status information of channels that are not used any more from their tables when the duration elapses.

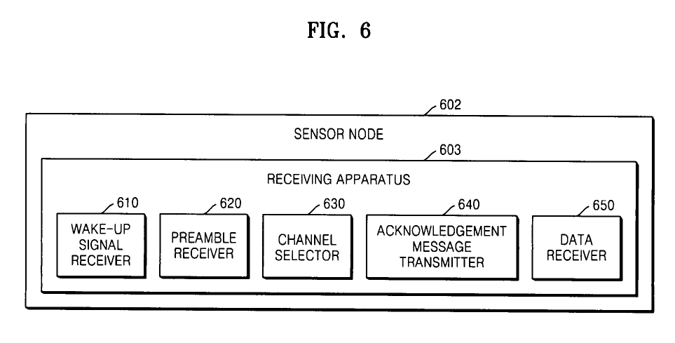

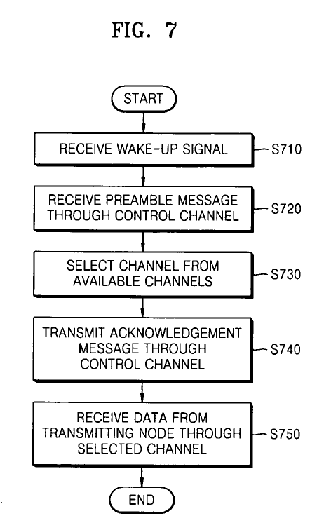

FIG. 6 is a block diagram of a receiving apparatus 603 of a sensor node 602 according to an embodiment of the present invention, and FIG. 7 is a flow chart illustrating a receiving method performed in the receiving apparatus 603 of the sensor node 602 illustrated in FIG. 6 according to an embodiment of the present invention. The receiving apparatus and the receiving method illustrated in FIGS. 6 and 7 receive the control message and data transmitted from the transmitting apparatus and the transmitting method illustrated in FIGS. 1 and 2. Accordingly, descriptions of the control message and data transmitted and received in the transmitting apparatus and the transmitting method illustrated in FIGS. 1 and 2 are applied to the control message and data transmitted and received in the receiving apparatus and the receiving method illustrated in FIGS. 6 and 7. In the current embodiment of the present invention, the sensor node 602 corresponds to the receiving node described with reference to FIGS. 1, 2, 3 and 4 and a transmitting node corresponds to the sensor node 100 described with reference to FIGS. 1, 2, 3 and 4.

Referring to FIGS. 6 and 7, the receiving apparatus 603 of the sensor node 602 includes a wake-up signal receiver 610, a preamble receiver 620, a channel selector 630, an acknowledgement message transmitter 640 and a data receiver 650. The wake-up signal receiver 610 receives a wake-up signal from a transmitting node in a receiving range of the sensor node 602 in operation S710. The wake-up signal switches a power-saving mode to a wake-up mode for waiting to receive a message from the transmitting node.

The preamble receiver 620 receives a preamble message including a list of available channels from among data channels from the transmitting node through a control channel in the wake-up mode switched by the wake-up signal in operation S720. The channel selector 630 selects an unused channel from the available channel list included in the preamble message in operation S730.

The receiving apparatus 603 of the sensor node 602 can further include a channel status information storage unit (not shown) storing status information of the data channels. In this case, the channel selector 630 selects an unused channel from the available channels on the basis of the status information stored in the channel status information storage unit (not shown). When the available channels include at least two unused channels, the channel selector 630 selects one of the unused channels.

The acknowledgement message transmitter 640 transmits an acknowledgement message including information that indicates the channel selected by the channel selector 630 to the transmitting node through the control channel in operation S740. The data receiver 650 receives data from the transmitting node through the selected channel in operation S750.

The receiving apparatus 603 of the sensor node 602 can further include a connection confirmation message receiver (not shown) receiving a connection confirmation message that represents connection of the transmitting node to the selected channel through the control channel. In this case, the connection confirmation message receiver (not shown) receives the connection confirmation message, and then data is received from the transmitting node through the selected channel.

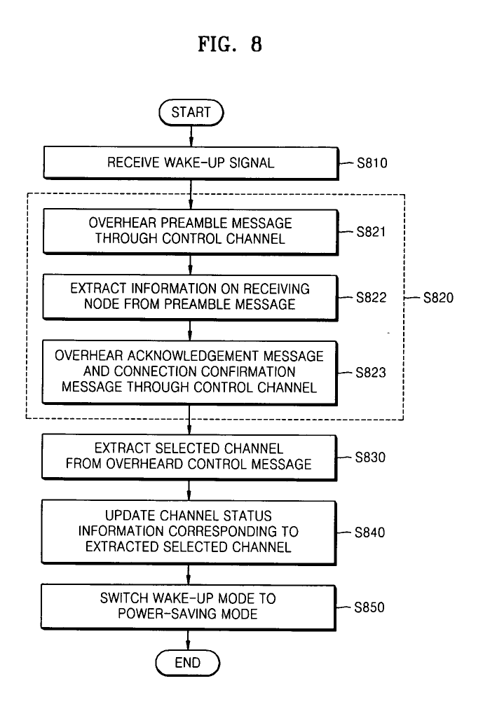

FIG. 8 is a flow chart illustrating a channel status information updating method of a sensor node according to an embodiment of the present invention. FIG. 8 illustrates a method of overhearing a control message transmitted and received by the sensor node 100 switched to the wake-up mode according to the wake-up signal in the transmitting apparatus and the transmitting method illustrated in FIGS. 1 and 2 and updating channel status information. Accordingly, description of the control message transmitted and received in the transmitting apparatus and the transmitting method illustrated in FIGS. 1 and 2 is applied to the control message transmitted and received in the channel status information updating method illustrated in FIG. 8. In the current embodiment of the present invention, the sensor node corresponds to neighbor nodes other than the receiving node described with reference to FIGS. 1, 2, 3 and 4, a transmitting node corresponds to the sensor node 100 described with reference to FIGS. 1, 2, 3 and 4, and a receiving node corresponds to the receiving node explained with reference to FIGS. 1, 2, 3 and 4.

Referring to FIG. 8, a wake-up signal that switches a power-saving mode to a wake-up mode for waiting to receive a message from a transmitting node in a receiving range of the sensor node is received from a transmitting node in operation S810. A control message transmitted between the transmitting node and a receiving node to which data is transmitted from the transmitting node through a control channel is overheard in the wake-up mode switched by the wake-up signal in operation S820. The control message includes a preamble message that requests the receiving node to connect with the transmitting node for data transmission, an acknowledgement message representing that the receiving node receives the preamble message, and a connection confirmation message representing that the transmitting node and the receiving node are connected to each other through a selected channel.

Specifically, the preamble message is overheard through the control channel in operation S821. Information indicating the receiving node is extracted from the overheard preamble message in operation S822. The acknowledgement message and/or the connection confirmation message transmitted between the transmitting node and the receiving node known in operation S822 are overheard in operation S823.

A selected channel to be used for communication between the transmitting node and the receiving node is extracted from the control message, which is overheard in operation S823, in operation S830. Channel status information corresponding to the extracted selected channel is updated in operation S840. When the control message corresponds to the connection confirmation message, the wake-up mode is switched to the power-saving mode in operation S850.

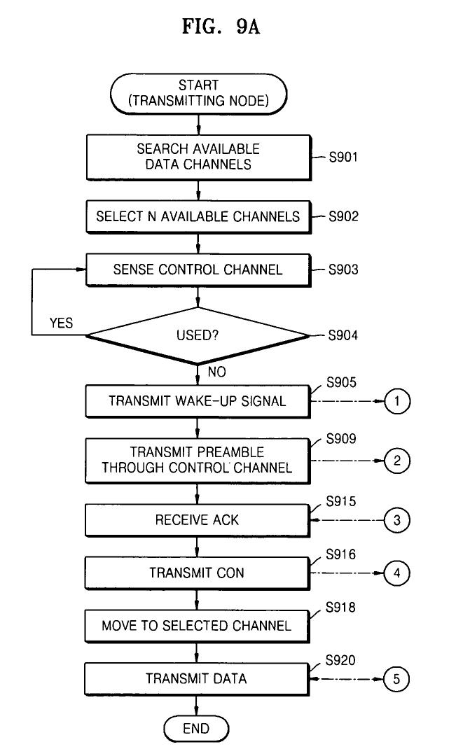

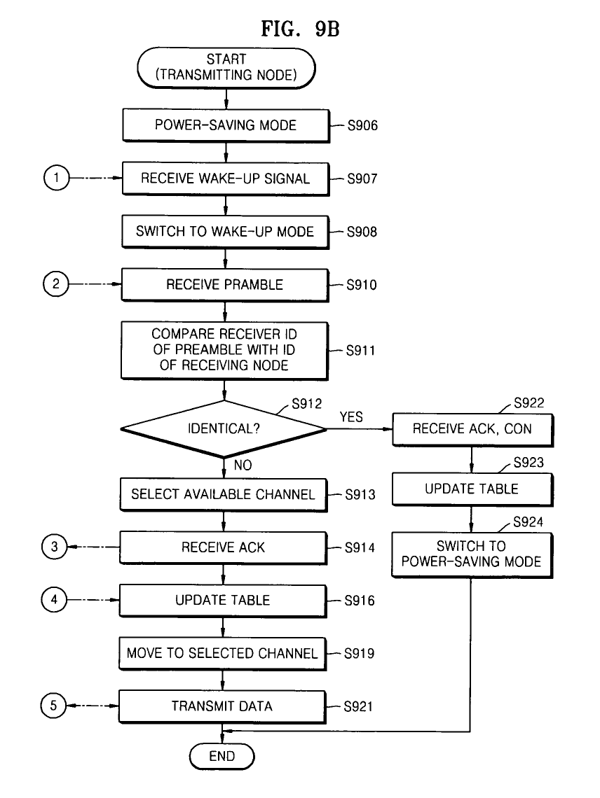

FIGS. 9A and 9B are flow charts illustrating a transmitting and receiving method of a sensor node according to an embodiment of the present invention. Referring to FIGS. 9A and 9B, a transmitting node confirms information included in a table thereof and selects n available data channels that are not currently used in operations S901 and S902. Here, n represents a maximum channel number that can be included in an available channel list of a preamble message. When there are more than n unused data channels, n channels can be randomly selected.

The transmitting node determines whether a control channel is currently used in operation S903 and transmits a wake-up signal through the control channel when the control channel is not used in operations S904 and S905. Nodes in a power-saving mode in which main RF receivers of the nodes are turned off and wake-up signal receivers of the nodes are turned on receive a wake-up signal in operations S906 and S907 to turn on the main RF receivers in operation S908 and receive a preamble message from the transmitting node in operations S909 and S910.

Then, the nodes compare a receiver ID of the received preamble message with their IDs in operation S911. When the receiver ID corresponds to the IDs of the nodes in operation S921, each of the nodes selects one of available channels of the preamble message on the basis of channel status information of a table thereof in operation S913 and transmits an acknowledgement message including information that indicates the selected channel in operation S914.

The transmitting node receives the acknowledgement message in operation S915 and transmits a connection confirmation message in operation S916. A receiving node updates channel status information of a table thereof according to the received connection confirmation message in operation S917.

The transmitting node and the receiving node move to the selected channel in operations S918 and S919 and transmit and receive data through the selected channel in operations S920 and S921.

Nodes other than the receiving node woken by the wake-up signal receive the preamble message, the acknowledgement message and the connection confirmation message transmitted and received between the transmitting node and the receiving node in operation S922, update their tables based on information included in the preamble message, the acknowledgement message and the connection confirmation message in operation S923, and are switched to the power-saving mode after receiving the connection confirmation message in operation S924.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A transmitting apparatus of a sensor node based on multiple channels including a control channel and a plurality of data channels, the transmitting apparatus comprising:
a wake-up signal transmitter transmitting a wake-up signal for switching neighbor nodes in a power-saving mode in a transmission range of the sensor node to a wake-up mode in which the neighbor nodes wait to receive a message from the sensor node through the control channel;
a preamble transmitter transmitting a preamble message including a list of unused available channels from among the data channels to a receiving node to which data is transmitted from among the neighbor nodes through the control channel;
an acknowledgement message receiver receiving an acknowledgement message including information that indicates a channel selected from the available channels from the receiving node through the control channel;
a connection confirmation message transmitter transmitting a connection confirmation message for switching neighbor nodes other than the receiving node to the power-saving mode through the control channel; and
a data transmitter transmitting data to the receiving node through the selected channel.

2. The transmitting apparatus of claim 1, further comprising a channel status information storage unit storing status information of the data channels, the list of the available channels is extracted on the basis of the status information stored in the channel status information storage unit.

3. The transmitting apparatus of claim 1, wherein the preamble message includes information indicating the sensor node, information indicating the receiving node and a time estimated to use the selected channel through which the sensor node and the receiving node transmit and receive data.

4. The transmitting apparatus of claim 1, wherein the acknowledgement message includes information indicating the sensor node, information indicating the receiving node and a time estimated to use the selected channel.

5. The transmitting apparatus o claim 1, wherein the connection confirmation message includes information indicating the sensor node, information indicating the receiving node, information indicating the selected channel and a time estimated to use the selected channel.

6. A transmitting method of a sensor node based on multiple channels including a control channel and a plurality of data channels, the transmitting method comprising:
transmitting a wake-up signal for switching neighbor nodes in a power-saving mode in a transmission range of the sensor node to a wake-up mode in which the neighbor nodes wait to receive a message from the sensor node through the control channel;
transmitting a preamble message including a list of unused available channels from among the data channels to a receiving node to which data is transmitted from among the neighbor nodes through the control channel;
receiving an acknowledgement message including information that indicates a channel selected from the available channels from the receiving node through the control channel;
transmitting a connection confirmation message for switching neighbor nodes other than the receiving node to the power-saving mode through the control channel; and
transmitting data to the receiving node through the selected channel.

7. The transmitting method of claim 6, wherein the sensor node stores status information of the data channels and the list of the available channels is extracted on the basis of the stored status information.

8. The transmitting method of claim 6, wherein the preamble message includes information indicating the sensor node, information indicating the receiving node and a time estimated to use the selected channel through which the sensor node and the receiving node transmit and receive data.

9. The transmitting method of claim 6, wherein the acknowledgement message includes information indicating the sensor node, information indicating the receiving node and a time estimated to use the selected channel.

10. The transmitting method of claim 6, wherein the connection confirmation message includes information indicating the sensor node, information indicating the receiving node, information indicating the selected channel and a time estimated to use the selected channel.

11. A receiving apparatus of a sensor node based on multiple channels including a control channel and a plurality of data channels, the receiving apparatus comprising:
a wake-up signal receiver receiving a wake-up signal for switching a power-saving mode to a wake-up mode for waiting to receive a message from a transmitting node in a receiving range of the sensor node from the transmitting node;
a preamble receiver receiving a preamble message including a list of available channels from among the data channels from the transmitting node through the control channel in the wake-up mode;
a channel selector selecting an unused channel from the available channels;
an acknowledgement message transmitter transmitting an acknowledgement message including information that indicates the selected channel to the transmitting node through the control channel; and
a data receiver receiving data from the transmitting node through the selected channel.

12. The receiving apparatus of claim 11, further comprising a channel status information storage unit storing status information of the data channels, and the channel selector selects the channel based on the stored status information.

13. The receiving apparatus of claim 11, wherein the preamble message includes information indicating the transmitting node, information indicating the sensor node and a time estimated to use the selected channel.

14. The receiving apparatus of claim 11, wherein the acknowledgement message includes information indicating the transmitting node, information indicating the sensor node and a time estimated to use the selected channel.

15. The receiving apparatus of claim 11, further comprising a connection confirmation message receiver receiving a connection confirmation message that represents connection with the transmitting node through the selected channel through the control channel, and the connection confirmation message includes information indicating the transmitting node, information indicating the sensor node, information indicating the selected channel and a time estimated to use the selected channel.

16. A receiving method of a sensor node based on multiple channels including a control channel and a plurality of data channels, the receiving method comprising:
receiving a wake-up signal for switching a power-saving mode to a wake-up mode for waiting to receive a message from a transmitting node in a receiving range of the sensor node from the transmitting node;
receiving a preamble message including a list of available channels from among the data channels from the transmitting node through the control channel in the wake-up mode;
selecting an unused channel from the available channels;
transmitting an acknowledgement message including information that indicates the selected channel to the transmitting node through the control channel; and
receiving data from the transmitting node through the selected channel.

17. The receiving method of claim 16, wherein the sensor node stores status information of the data channels, and the selecting of the unused channel comprises selecting the unused channel based on the stored status information.

18. The receiving method of claim 16, wherein the preamble message includes information indicating the transmitting node, information indicating the sensor node and a time estimated to use the selected channel.

19. The receiving method of claim 16, wherein the acknowledgement message includes information indicating the transmitting node, information indicating the sensor node and a time estimated to use the selected channel.

20. The receiving method of claim 16, further comprising receiving a connection confirmation message that represents connection with the transmitting node through the selected channel through the control channel, and the connection confirmation message includes information indicating the transmitting node, information indicating the sensor node, information indicating the selected channel and a time estimated to use the selected channel.

21. A channel status information updating method of a sensor node based on multiple channels including a control channel and a plurality of data channels, the channel status information updating method comprising:
receiving a wake-up signal for switching a power-saving mode to a wake-up mode for waiting to receive a message of a transmitting node in a receiving range of the sensor node from the transmitting node;
overhearing a control message transmitted and received between the transmitting node and a receiving node through the control channel in the wake-up mode;
extracting a selected channel to be used for data communication between the transmitting node and the receiving node from the overheard control message; and
updating channel status information corresponding to the extracted selected channel.

22. The channel status information updating method of claim 21, wherein the overhearing of the control message comprises:
overhearing a preamble message that requests the receiving node to connect with the transmitting node for data transmission through the control channel;
extracting information indicating the receiving node from the overheard preamble message; and
overhearing an acknowledgement message and the connection confirmation message transmitted and received between the transmitting node and the receiving node.

23. The channel status information updating method of claim 21, wherein the control message includes at least one of a preamble message that requests the receiving node to connect with the transmitting node for data transmission, an acknowledgement message representing that the receiving node receives the preamble message, and a connection confirmation message representing that the transmitting node and the receiving node are connected to each other through the selected channel.

24. The channel status information updating method of claim 21, further comprising switching the wake-up mode to the power-saving mode when the control message corresponds to the connection confirmation message representing that the transmitting node and the receiving node are connected to each other through the selected channel.

25. The channel status information updating method of claim 21, wherein the sensor node includes a channel status information storage unit storing status information of the data channels.
